(19) United States
(12) Patent Application Publication
(10) Pub. No.: US 2020/0341394 A1
(43) Pub. Date: Oct. 29, 2020

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Kenichi Ikari, Abiko-shi (JP); Koichi Nakata, Tokyo (JP); Haruki Mori, Nagareyama-shi (JP); Shubun Kujirai, Toride-shi (JP)

(21) Appl. No.: 16/855,022

(22) Filed: Apr. 22, 2020

(30) Foreign Application Priority Data
Apr. 26, 2019 (JP) 2019-086302

(51) Int. Cl. G03G 5/147; G03G 5/047; G03G 5/05; G03G 5/06; G03G 21/18; G03G 15/00

(52) U.S. Cl. CPC G03G 5/14739; G03G 5/047; G03G 15/75; G03G 5/06145; G03G 21/1814; G03G 5/055

(57) ABSTRACT

Provided is an electrophotographic photosensitive member having a satisfactory suppressing effect on image smearing. The electrophotographic photosensitive member includes: a support; a photosensitive layer; and a surface layer, the surface layer containing at least one of melamine resin-containing particles and acrylic resin-containing particles, and a polymerized product of a composition containing a charge-transporting compound having a polymerizable functional group; and a compound represented by formula (1):

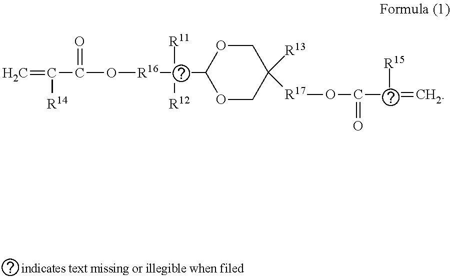

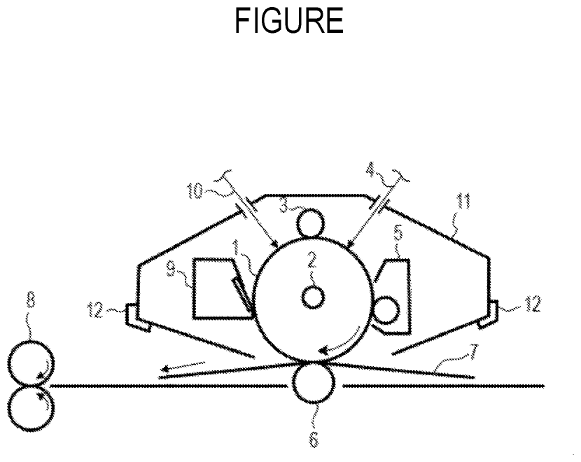

### BACKGROUND

The present disclosure is directed to an electrophotographic photosensitive member, and a process cartridge and an electrophotographic apparatus each including the electrophotographic photosensitive member.

### DESCRIPTION OF THE RELATED ART

An electrical external force or a mechanical external force, such as charging or cleaning, is applied to the surface of an electrophotographic photosensitive member, and hence the surface is required to have durability (e.g., wear resistance) against these external forces.

To cope with the requirement, a technology involving, for example, using a resin having high wear resistance (e.g., a curable resin) in the surface layer of the electrophotographic photosensitive member has heretofore been used.

Meanwhile, in order to improve the cleaning property and lubricity of the surface of the electrophotographic photosensitive member, there has been known a technology involving adding organic resin particles to the surface layer thereof containing a curable resin or a resin having a crosslinked structure.

In Japanese Patent Application Laid-Open No. 2006-267467, there is a description of a technology for the production of an electrophotographic photosensitive member that achieves both of wear resistance and a cleaning property, the technology involving designing the surface of a surface layer containing a resin having a crosslinked structure and melamine resin fine particles or crosslinked acrylic resin fine particles so that the surface may have a desired roughness.

In Japanese Patent Application Laid-Open No. 2016-95340, there is a description of a technology for the production of an electrophotographic photosensitive member excellent in wear resistance and cleaning property, the technology involving subjecting organic particles to be added to a surface layer containing a curable resin to a specific surface treatment.

At least one embodiment of the present disclosure is directed to the provision of an electrophotographic photosensitive member having a satisfactory suppressing effect on image smearing.

In addition, at least one embodiment of the present disclosure is directed to the provision of a process cartridge capable of more satisfactorily suppressing the occurrence of image smearing.

Further, at least one embodiment of the present disclosure is directed to the provision of an electrophotographic apparatus capable of forming a high-quality electrophotographic image.

### SUMMARY

According to at least one embodiment of the present disclosure, there is provided an electrophotographic photosensitive member comprising: a support; a photosensitive layer; and a surface layer, wherein the surface layer contains: at least one of melamine resin-containing particles and acrylic resin-containing particles, and a polymerized product of a composition containing a charge-transporting compound having a polymerizable functional group, and a compound represented by formula (1):

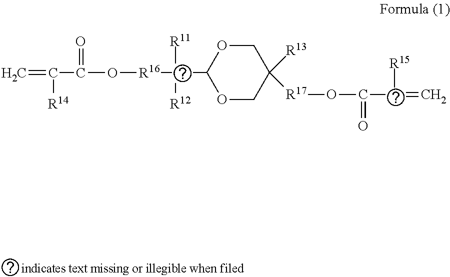

in the formula (1), R¹¹ and R¹² each independently represent an alkyl group having 1 or more and 4 or less carbon atoms, or a substituted or unsubstituted aryl group, and R¹¹ and R¹² may be bonded to each other to form an aliphatic ring, R¹³ represents an alkyl group having 1 or more and 4 or less carbon atoms, R¹⁴ and R¹⁵ each independently represent a hydrogen atom or a methyl group, and R¹⁶ and R¹⁷ each independently represent an alkylene group having 1 or more and 4 or less carbon atoms.

According to at least one embodiment of the present disclosure, there is provided a process cartridge removably mounted onto a main body of an electrophotographic apparatus, comprising the electrophotographic photosensitive member and at least one unit selected from the group consisting of a charging unit, a developing unit, and a cleaning unit.

According to at least one embodiment of the present disclosure, there is provided an electrophotographic apparatus comprising: the electrophotographic photosensitive member; a charging unit, an exposing unit, a developing unit, and a transferring unit.

Further features of the present invention will become apparent from the following description of exemplary embodiments with reference to the attached drawing.

### BRIEF DESCRIPTION OF THE DRAWINGS

FIGURE is a schematic configuration view of an electrophotographic apparatus mounted with a process cartridge including an electrophotographic photosensitive member according to at least one embodiment of the present disclosure.

### DESCRIPTION OF THE EMBODIMENTS

Melamine resin-containing particles or acrylic resin-containing particles tend to show high hydrophilicity because many hydroxy groups are present on the surfaces of the particles. The inventors have made an investigation, and as a result, have found that an electrophotographic photosensitive member containing such particles in its surface layer shows excellent lubricity and an excellent cleaning property, and that at the same time, the hydrophilicity of the toner-carrying surface (hereinafter sometimes referred to as “surface”) of the electrophotographic photosensitive member becomes higher, and hence the level of an image defect (image smearing) occurring under a high-humidity environment worsens.

Even the electrophotographic photosensitive members disclosed in Japanese Patent Application Laid-Open No. 2006-267467 and Japanese Patent Application Laid-Open No. 2016-95340, the electrophotographic photosensitive members each containing the melamine resin fine particles or the acrylic resin fine particles in its surface layer, have each been unable to exhibit a sufficiently satisfactory suppressing effect on the image smearing under the high-humidity environment in some cases.

The image smearing is a phenomenon in which an electrostatic latent image blurs, and hence an output image blurs. The phenomenon is assumed to be caused by the following: moisture present on the surface of an electrophotographic photosensitive member or in air reacts with a discharge product produced by the charging of the electrophotographic photosensitive member, and the reaction product alters a constituent material for the surface layer thereof. Along with a recent improvement in wear resistance of the electrophotographic photosensitive member, the surface of the electrophotographic photosensitive member becomes hardly refreshed, and hence the discharge product is liable to remain on the surface of the electrophotographic photosensitive member owing to its repeated use. As a result, measures against, in particular, the image smearing are required.

With regard to conventional image smearing suppression, in order to evaporate the moisture that is one cause of the image smearing, a method including arranging a drum heater to increase the surface temperature of the electrophotographic photosensitive member has been used. From the viewpoint of the energy conservation of an electrophotographic apparatus, however, the inventors have obtained a finding that a new technology by which the image smearing can be suppressed without the use of any drum heater needs to be developed.

In view of the foregoing, the inventors have made further investigations, and as a result, have found that an electrophotographic photosensitive member including a surface layer containing a specific polymerized product can effectively suppress the image smearing without using any drum heater.

An electrophotographic photosensitive member and the like according to at least one embodiment of the present disclosure are described in detail below by way of a preferred embodiment.

An electrophotographic photosensitive member according to at least one embodiment of the present disclosure includes a support, a photosensitive layer, and a surface layer.

The surface layer contains at least one of melamine resin-containing particles and acrylic resin-containing particles, and a polymerized product of a composition including a charge-transporting compound having a polymerizable functional group, and a compound represented by formula (1):

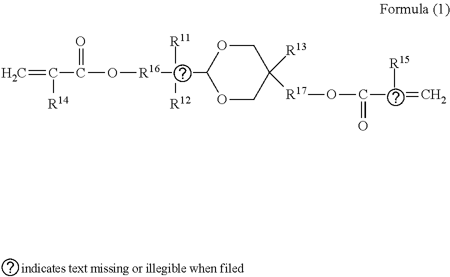

in the formula (1), R¹¹ and R¹² each independently represent an alkyl group having 1 or more and 4 or less carbon atoms, or a substituted or unsubstituted aryl group, and R¹² may be bonded to each other to form an aliphatic ring, R¹³ represents an alkyl group having 1 or more and 4 or less carbon atoms, R¹⁴ and R¹⁵ each independently represent a hydrogen atom or a methyl group, and R¹⁶ and R¹⁷ each independently represent an alkylene group having 1 or more and 4 or less carbon atoms.

The inventors have considered the mechanism via which the electrophotographic photosensitive member can suppress image smearing to be as

While the surface layer containing the charge-transporting compound having a polymerizable functional group has high wear resistance, the image smearing is liable to occur owing to the high wear resistance. In addition, when the wear resistance is high, a friction resistance between the surface of the surface layer and a blade increases, and hence torque increases to destabilize the behavior of the blade. Accordingly, the cleaning property of the electrophotographic photosensitive member is liable to reduce. In view of the foregoing, an investigation has been made on the improvement of the cleaning property through the following: one or both of the melamine resin-containing particles and the acrylic resin-containing particles are incorporated into the surface layer to improve the lubricity of the surface of the electrophotographic photosensitive member, that is, to reduce the friction resistance, thereby stabilizing the behavior of the blade.

However, the inventors have made an investigation, and as a result, have found that when the above-mentioned particles are used in the surface layer, the image smearing may be liable to occur. The foregoing is considered to result from the fact that when the melamine resin-containing particles or the acrylic resin-containing particles are used, the hydrophilicity of the surface of the electrophotographic photosensitive member becomes higher to attract moisture serving as a cause of the image smearing, thereby increasing the amount of the moisture in the surface layer.

In at least one embodiment of the present disclosure, the image smearing can be suppressed the surface layer including at least one of the melamine resin-containing particles an d the acrylic resin-containing particles, and the polymerized product of the composition containing the charge-transporting compound having a polymerizable functional group and the compound represented by the formula (1).

It is considered that since the compound represented by the formula (1) has appropriate properties such as a molecular size and a molecular weight, the denseness of the surface layer containing the polymerized product increases, and therefore moisture invasion into the surface layer can be effectively prevented. Thus, it is conceivable that even when the hydrophilicity of the surface of the electrophotographic photosensitive member becomes higher due to the incorporation of the melamine resin-containing particles or the acrylic resin-containing particles into the surface layer, the increase of moisture content in the surface layer can be prevented, and hence the image smearing is suppressed.

As described above, in at least one embodiment of the present disclosure, the three kinds of materials, that is, the charge-transporting compound having a polymerizable functional group, the compound represented by the formula (1), and at least one of the melamine resin-containing particles and the acrylic resin-containing particles effectively act on each other in the surface layer. Thus, an electrophotographic photosensitive member having a satisfactory suppressing effect on image smearing can be provided.

That is, the effect of the present disclosure can be achieved by the synergistic effect of the respective configurations on each other.

The configuration of the electrophotographic photosensitive member according to at least one embodiment of the present disclosure is described below.

The electrophotographic photosensitive member includes the surface layer containing: at least one of the melamine resin-containing particles or the acrylic resin-containing particles; and the polymerized product of the composition containing the charge-transporting compound having a polymerizable functional group, and the compound represented by the formula (1).

### <Compound Represented by Formula (1)>

The compound represented by the formula (1) is a compound free of any charge-transporting property.

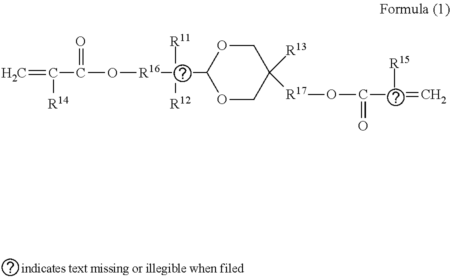

In the formula (1), R¹¹ and R¹² each independently represent an alkyl group having 1 or more and 4 or less carbon atoms, or a substituted or unsubstituted aryl group.

A substituent that the aryl group may have is, for example, an alkyl group having 1 or more and 4 or less carbon atoms.

R¹¹ and R¹² may be bonded to each other to form an aliphatic ring. The compound of formula (1) of which R¹¹ and R¹² each represent an alkyl group having 1 or more and 4 or less carbon atoms, has a compact molecular size, and hence the denseness of the surface layer can be increased as stated above. In particular, at least one of R¹¹ and R¹² may preferably be an alkyl group having 2 or more carbon atoms, the denseness of the surface layer can be more improved, and moisture invasion into the surface layer can more effectively suppressed. As a result of that, the suppressing of image smearing can be more effectively prevented.

In addition, when R¹¹ and R¹² are bonded to each other to form an aliphatic ring, examples of the aliphatic ring include, but not limited to, cyclopropane, cyclopentane, cyclohexane, cycloheptane, and cyclooctane.

R¹³ represents an alkyl group having 1 or more and 4 or less carbon atoms.

R¹⁴ and R¹⁵ each independently represent a hydrogen atom or a methyl group. R¹⁶ and R¹⁷ each independently represent an alkylene group having 1 or more and 4 or less carbon atoms. Of the alkylene groups, a methylene group or an ethylene group is preferred from the viewpoints of the denseness and film strength of the film.

Specific examples (Exemplified Compounds) of the compound represented by the formula (1) are given below. However, the compound represented by the formula (1) is not limited thereto.

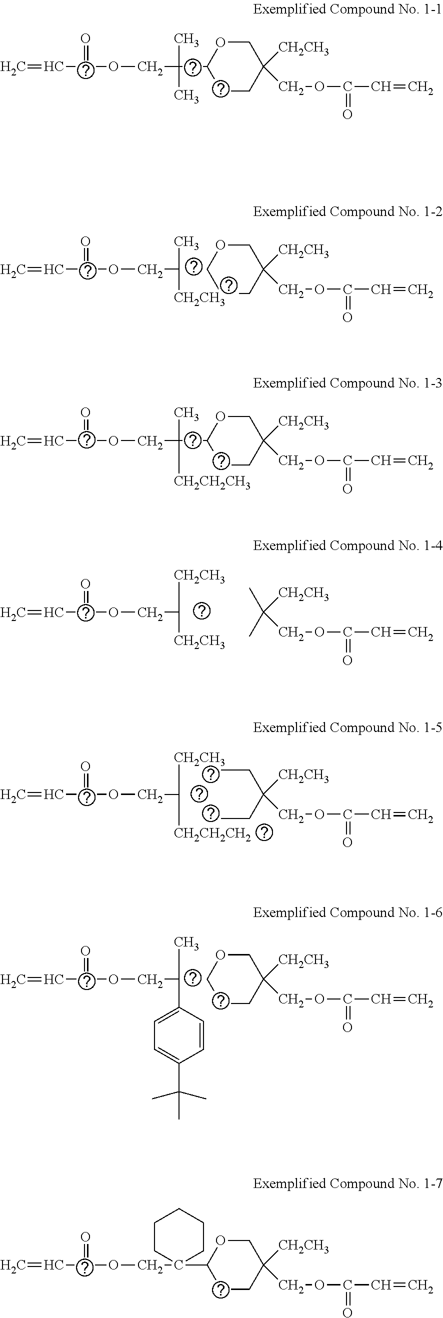

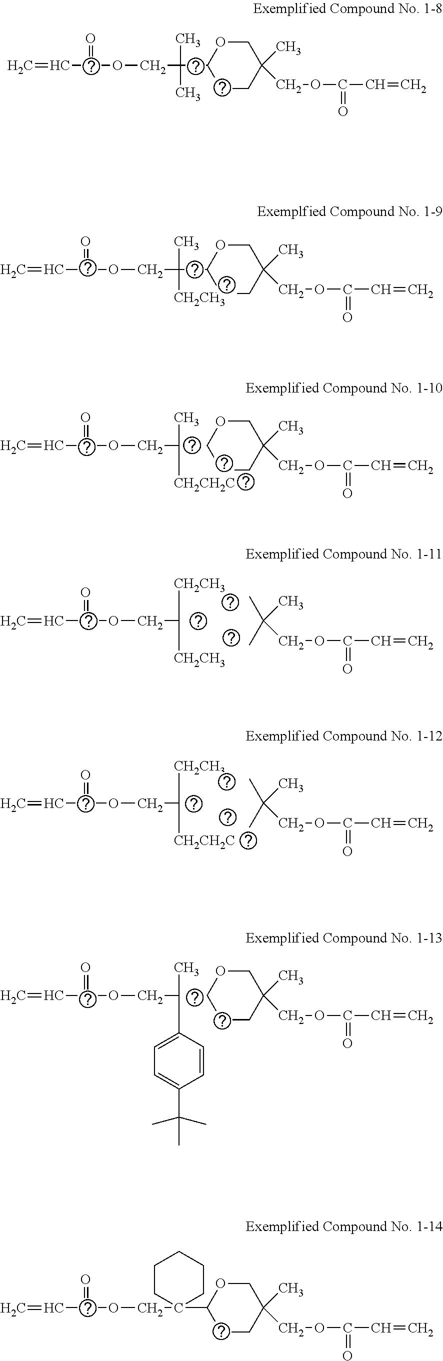

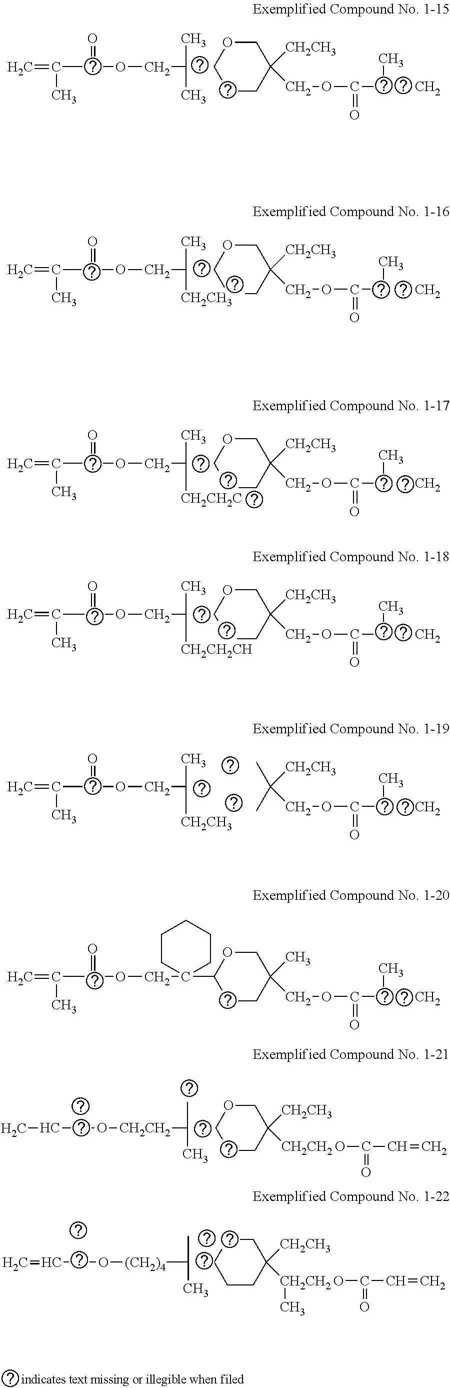

### <Charge-Transporting Compound Having Polymerizable Functional Group>

The charge-transporting compound having a polymerizable functional group is a compound having, in one and the same molecule, the polymerizable functional group and a skeleton having a charge-transporting property. Examples of the polymerizable functional group include a hydroxyl group, a vinyl group, an acryloyloxy group, a methacryloyloxy group, a styryl group, a vinyl ether group, and an allyl group. An example of the skeleton having a charge-transporting property is a skeleton having a hole-transporting property, such as hydrazone, carbazole, or triphenylamine.

As the polymerizable functional group, an acryloyloxy group and a methacryloyloxy group each serving as a chain polymerizable functional group are preferred from the viewpoints of, for example, a polymerizable characteristic and a polymerization rate.

Examples of a method for subjecting the polymerizable functional group to a polymerization reaction includes applying energy such as irradiation of UV light, irradiation of an electron beam, and heating; using an auxiliary such as a polymerization initiator; and coexisting a compound such as an acid, an alkali and a complex.

Specific examples (Exemplified Compounds) of the charge-transporting compound having a polymerizable functional group are given below. However, the charge-transporting compound having a polymerizable functional group is not limited thereto. The reactive functional groups of the following exemplified compounds may each be substituted with any one of the above-mentioned reactive functional groups. The substituents thereof may each be similarly substituted with any other structure.

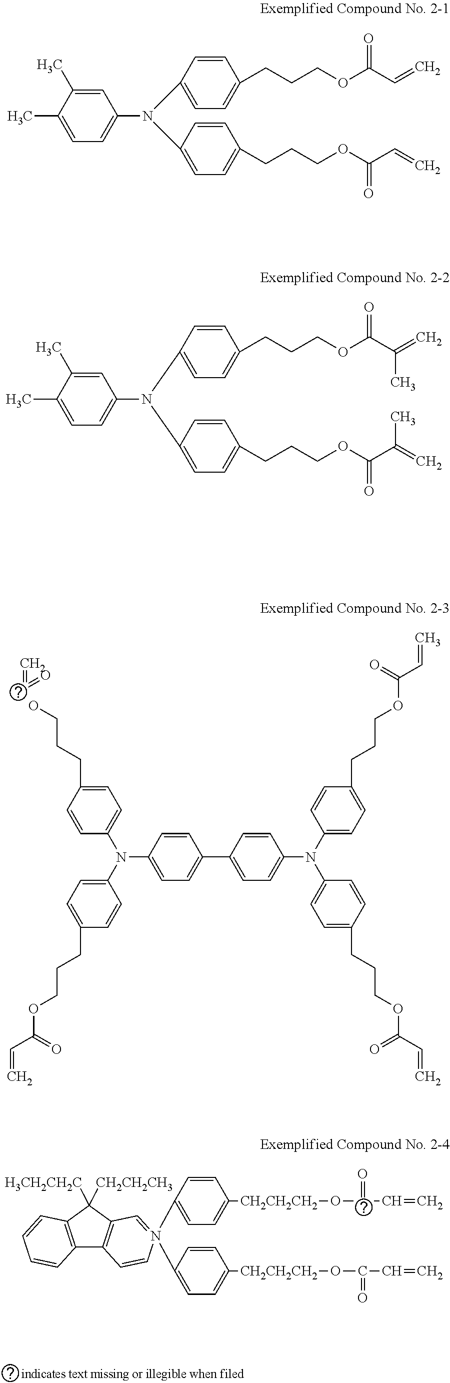

### <Melamine Resin-Containing Particles>

The melamine resin-containing particles each contain a resin having a melamine structure. Of such particles, particles each containing a melamine formaldehyde resin are preferred, and particles each formed of a melamine formaldehyde resin are more preferred.

The polymerization degree of the melamine resin of each of the particles, and whether the resin is thermoplastic or thermosetting are not particularly limited. The average particle diameter of the melamine resin-containing particles is preferably 0.1 μm or more and 2.0 μm or less.

Commercially available melamine resin-containing particles are, for example, melamine formaldehyde resin particles (product names: EPOSTAR SS, EPOSTAR S, EPOSTAR FS, EPOSTAR S6, and EPOSTAR S12, manufactured by Nippon Shokubai Co., Ltd.), and melamine benzoguanamine resin particles (product name: EPOSTAR M30, manufactured by Nippon Shokubai Co., Ltd.).

### <Content Ratio of Melamine Resin-containing Particles>

When the mass of the melamine resin-containing particles incorporated into the surface layer is represented by A, and the mass of a moiety derived from the compound represented by the formula (1), the compound being incorporated thereinto, is represented by B, the ratio (B/A) of the B to the A is preferably 9.7 mass % or more. When the ratio falls within the range, an electrophotographic photosensitive member having a satisfactory suppressing effect on an image defect due to image smearing is obtained.

In addition, when the mass of a moiety derived from the charge-transporting compound having a polymerizable functional group, the compound being incorporated into the surface layer, is represented by C, the ratio (B/C) of the B to the C is preferably 5.3 mass % or more. When the ratio falls within the range, an electrophotographic photosensitive member having a satisfactory suppressing effect on an image defect due to image smearing is obtained.

Further, a case in which a relationship A/(A+B+C) among the A, the B, and the C falls within the range of from 10.2 mass % or more to 34.0 mass % or less is preferred because an electrophotographic photosensitive member having more satisfactory rub resistance and a more satisfactory suppressing effect on image smearing is obtained.

### <Acrylic Resin-Containing Particles>

The acrylic resin-containing particles each contain a polymer of an acrylate or a methacrylate. Of such particles, styrene acrylic resin-containing particles are preferred, and particles each formed of a styrene acrylic resin are more preferred. The polymerization degree of the acrylic resin or styrene acrylic resin of each of the particles, and whether the resin is thermoplastic or thermosetting are not particularly limited. The average particle diameter of the acrylic resin-containing particles is preferably 0.1 μm or more and 2.0 μm or less.

Commercially available acrylic resin-containing particles are, for example, the following particles.
Fine sphere: FS-101, FS-102, FS-107, FS-201, FS-301, MG-155, MG-351, and MG-451; all of which are product names, manufactured by Nippon Paint Industrial Coatings Co., Ltd.
TECHPOLYMER: SSX-101, SSX-102, SSX-103, SSX-104, and SSX-105, all of which are product names, manufactured by Sekisui Plastics Co., Ltd.
Highly crosslinked particles: SX8002; product name, manufactured by JSR Corporation
Polymethyl methacrylate powder: XX-159AP and XX-160AP; all of which are product names, manufactured by Sekisui Plastics Co., Ltd.

### <Content Ratio of Acrylic Resin-containing Particles>

When the mass of the acrylic resin-containing particles incorporated into the surface layer is represented by A, and the mass of the moiety derived from the compound represented by the formula (1), the compound being incorporated thereinto, is represented by B, the ratio (B/A) of the B to the A is preferably 13.6 mass % or more. When the ratio falls within the range, an electrophotographic photosensitive member having a satisfactory suppressing effect on an image defect due to image smearing is obtained.

In addition, when the mass of the moiety derived from the charge-transporting compound having a polymerizable functional group, the compound being incorporated into the surface layer, is represented by C, the ratio (B/C) of the B to the C is preferably 5.3 mass % or more. When the ratio falls within the range, an electrophotographic photosensitive member having a satisfactory suppressing effect on an image defect due to image smearing is obtained.

Further, a case in which a relationship A/(A+B+C) among the A, the B, and the C falls within the range of from 8.2 mass % or more to 27.3 mass % or less is preferred because an electrophotographic photosensitive member having more satisfactory rub resistance and a more satisfactory suppressing effect on image smearing is obtained.

The surface layer may contain conductive particles. Examples of the conductive particles include particles of metal oxides, such as titanium oxide, zinc oxide, tin oxide, and indium oxide.

The surface layer may contain a charge-transporting compound free of any polymerizable functional group. Examples of the charge-transporting compound free of any polymerizable functional group include a polycyclic aromatic compound, a heterocyclic compound, a hydrazone compound, a styryl compound, an enamine compound, a benzidine compound, a triarylamine compound, and a resin having a group derived from each of those substances. Of those, a triarylamine compound and a benzidine compound are preferred.

The surface layer may contain a resin. Examples of the resin include a polyester resin, an acrylic resin, a phenoxy resin, a polycarbonate resin, a polystyrene resin, a phenol resin, a melamine resin, and an epoxy resin. Of those, a polycarbonate resin, a polyester resin, and an acrylic resin are preferred.

The surface layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

As the fluorine resin particles, tetrafluoroethylene resin particles, trifluoroethylene resin particles, tetrafluoroethylene hexafluoropropylene resin particles, vinyl fluoride resin particles, vinylidene fluoride resin particles, and difluorodichloroethylene resin particles are preferred. In addition, particles of copolymers thereof are preferred. Of those, tetrafluoroethylene resin particles are more preferred.

When the fluorine resin particles are added to the surface layer, the content of the fluorine resin particles is preferably 5 mass % or more and 50 mass % or less, more preferably 15 mass % or more and 35 mass % or less with respect to the total mass of the surface layer.

The thickness of the surface layer is preferably 0.1 μm or more and 15 μm or less, more preferably 0.5 μm or more and 10 μm or less.

### <Production Method>

The surface layer may be formed by: forming a coat of a coating liquid for a surface layer containing the charge-transporting compound having a polymerizable functional group, the compound represented by the formula (1), and the melamine resin-containing particles or the acrylic resin-containing particles; and curing the coat.

As a solvent to be used for the preparation of the coating liquid for a surface layer, a solvent that does not dissolve a layer to be arranged below the surface layer is preferably used. Alcohol-based solvents, such as methanol, ethanol, propanol, isopropanol, 1-butanol, 2-butanol, and 1-methoxy-2-propanol, are more preferred.

A method of curing the coat of the coating liquid for a surface layer is, for example, a method including curing the coat with heat, UV light, or an electron beam. In order to maintain the strength of the surface layer and the durability of the electrophotographic photosensitive member, the coat is preferably cured with the UV light or the electron beam.

A case in which the coat is polymerized with the electron beam is preferred because an extremely dense (high-density) cured product (three-dimensional crosslinked structure) is obtained, and hence a surface layer having higher durability is obtained. When the electron beam is applied, an accelerator is, for example, a scanning-type, electrocurtain-type, broad beam-type, pulse-type, or laminar-type accelerator.

When the electron beam is used, the acceleration voltage of the electron beam is preferably 120 kV or less from the viewpoint that the deterioration of the characteristics of the materials for the surface layer by the electron beam can be suppressed without the impairment of the efficiency of the polymerization. In addition, the absorbed dose of the electron beam on the surface of the coat of the coating liquid for a surface layer is preferably 1 kGy or more and 50 kGy or less, more preferably 5 kGy or more and 10 kGy or less.

In addition, when the coat is cured (polymerized) with the electron beam, in order to suppress a polymerization-inhibiting action exhibited by oxygen, the coat is preferably heated in an inert gas atmosphere after having been irradiated with the electron beam in the inert gas atmosphere. Examples of the inert gas include nitrogen, argon, and helium.

### [Electrophotographic Photosensitive Member]

The electrophotographic photosensitive member includes the photosensitive layer and the surface layer on the support. The photosensitive layer is preferably a laminated photosensitive layer obtained by laminating a charge-generating layer and a charge-transporting layer in the stated order. A conductive layer or an undercoat layer may be arranged between the charge-generating layer and the support as required.

### <Support>

The support is preferably a conductive support having conductivity. In addition, examples of the shape of the support include a cylindrical shape, a belt shape, and a sheet shape. Of those, a cylindrical support is preferred. In addition, the surface of the support may be subjected to, for example, an electrochemical treatment, such as anodization, a blast treatment, or a cutting treatment.

A metal, a resin, glass, or the like is preferred as a material for the support.

Examples of the metal include aluminum, iron, nickel, copper, gold, stainless steel, and alloys thereof. Of those, an aluminum support using aluminum is preferred.

In addition, conductivity may be imparted to the resin or the glass through a treatment involving, for example, mixing or coating the resin or the glass with a conductive material.

### <Conductive Layer>

The conductive layer may be arranged on the support. The arrangement of the conductive layer can conceal flaws and irregularities in the surface of the support, and control the reflection of light on the surface of the support.

The conductive layer preferably contains conductive particles and a resin.

A material for the conductive particles is, for example, a metal oxide, a metal, or carbon black. Examples of the metal oxide include zinc oxide, aluminum oxide, indium oxide, silicon oxide, zirconium oxide, tin oxide, titanium oxide, magnesium oxide, antimony oxide, and bismuth oxide. Examples of the metal include aluminum, nickel, iron, nichrome, copper, zinc, and silver.

Of those, a metal oxide is preferably used as the conductive particles, and in particular, titanium oxide, tin oxide, and zinc oxide are more preferably used.

When the metal oxide is used as the conductive particles, the surface of the metal oxide may be treated with a silane coupling agent or the like, or the metal oxide may be doped with an element, such as phosphorus or aluminum, or an oxide thereof

In addition, each of the conductive particles may be of a laminated construction having a core particle and a coating layer coating the particle. Examples of the core particle include titanium oxide, barium sulfate, and zinc oxide. The coating layer is, for example, a metal oxide, such as tin oxide.

In addition, when the metal oxide is used as the conductive particles, their volume-average particle diameter is preferably 1 nm or more and 500 nm or less, more preferably 3 nm or more and 400 nm or less.

Examples of the resin include a polyester resin, a polycarbonate resin, a polyvinyl acetal resin, an acrylic resin, a silicone resin, an epoxy resin, a melamine resin, a polyurethane resin, a phenol resin, and an alkyd resin.

In addition, the conductive layer may further contain a concealing agent, such as a silicone oil, resin particles, or titanium oxide.

The conductive layer has an average thickness of preferably 1 μm or more and 50 μm or less, particularly preferably 3 μm or more and 40 μm or less.

The conductive layer may be formed by preparing a coating liquid for a conductive layer containing the above-mentioned materials and a solvent, forming a coat thereof, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent. As a dispersion method for dispersing the conductive particles in the coating liquid for a conductive layer, there are given methods using a paint shaker, a sand mill, a ball mill, and a liquid collision-type high-speed disperser.

### <Undercoat Layer>

The undercoat layer may be arranged on the support or the conductive layer. The arrangement of the undercoat layer can improve an adhesive function between layers to impart a charge injection-inhibiting function.

The undercoat layer preferably contains a resin. In addition, the undercoat layer may be formed as a cured film by polymerizing a composition containing a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide imide resin, and a cellulose resin.

Examples of the polymerizable functional group of the monomer having a polymerizable functional group include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group, and a carbon-carbon double bond group.

In addition, the undercoat layer may further contain an electron-transporting substance, a metal oxide, a metal, a conductive polymer, and the like for the purpose of improving electric characteristics. Of those, an electron-transporting substance and a metal oxide are preferably used.

Examples of the electron-transporting substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound, and a boron-containing compound. An electron-transporting substance having a polymerizable functional group may be used as the electron-transporting substance and copolymerized with the above-mentioned monomer having a polymerizable functional group to form the undercoat layer as a cured film.

Examples of the metal oxide include indium tin oxide, tin oxide, indium oxide, titanium oxide, zinc oxide, aluminum oxide, and silicon dioxide. Examples of the metal include gold, silver, and aluminum.

In addition, the undercoat layer may further contain an additive.

The undercoat layer has an average thickness of preferably 0.1 μm or more and 50 μm or less, more preferably 0.2 μm or more and 40 μm or less, particularly preferably 0.3 μm or more and 30 μm or less.

The undercoat layer may be formed by preparing a coating liquid for an undercoat layer containing the above-mentioned materials and a solvent, forming a coat thereof, and drying and/or curing the coat. Examples of the solvent to be used for the coating liquid include an alcohol-based solvent, a ketone-based solvent, an ether-based solvent, an ester-based solvent, and an aromatic hydrocarbon-based solvent.

### <Photosensitive Layer>

The photosensitive layer of the electrophotographic photosensitive member is mainly classified into (1) a laminated photosensitive layer and (2) a single-layer photosensitive layer. (1) The laminated photosensitive layer has a charge-generating layer containing a charge-generating substance and a charge-transporting layer containing a charge-transporting substance. (2) The single-layer photosensitive layer has a photosensitive layer containing both a charge-generating substance and a charge-transporting substance.

### (1) Laminated Photosensitive Layer

The laminated photosensitive layer has the charge-generating layer and the charge-transporting layer.

### (1-1) Charge-generating Layer

The charge-generating layer preferably contains the charge-generating substance and a resin.

Examples of the charge-generating substance include azo pigments, perylene pigments, polycyclic quinone pigments, indigo pigments, and phthalocyanine pigments. Of those, azo pigments and phthalocyanine pigments are preferred. Of the phthalocyanine pigments, an oxytitanium phthalocyanine pigment, a chlorogallium phthalocyanine pigment, and a hydroxygallium phthalocyanine pigment are preferred.

The content of the charge-generating substance in the charge-generating layer is preferably 40 mass % or more and 85 mass % or less, more preferably 60 mass % or more and 80 mass % or less with respect to the total mass of the charge-generating layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin, and a polyvinyl chloride resin. Of those, a polyvinyl butyral resin is preferred.

In addition, the charge-generating layer may further contain an additive, such as an antioxidant or a UV absorber. Specific examples thereof include a hindered phenol compound, a hindered amine compound, a sulfur compound, a phosphorus compound, and a benzophenone compound.

The charge-generating layer has an average thickness of preferably 0.1 μm or more and 1 μm or less, more preferably 0.15 μm or more and 0.4 μm or less.

The charge-generating layer may be formed by preparing a coating liquid for a charge-generating layer containing the above-mentioned materials and a solvent, forming a coat thereof, and drying the coat. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

### (1-2) Charge-transporting Layer

The charge-transporting layer preferably contains the charge-transporting substance and a resin.

Examples of the charge-transporting substance include charge-transporting compounds, such as a polycyclic aromatic compound, a heterocyclic compound, a hydrazone compound, a styryl compound, an enamine compound, a benzidine compound, and a triarylamine compound, and a resin having a group derived from each of those substances. Of those, a triarylamine compound and a benzidine compound are preferred.

A case in which the charge-transporting layer contains at least one charge-transporting compound selected from the group consisting charge-transporting compounds each represented by the following formula (2) or the following formula (3) out of those substances is preferred because at the time of the production of a configuration in which the photosensitive layer and the surface layer are laminated in the stated order, an electrophotographic photosensitive member improved in adhesiveness between the photosensitive layer and the surface layer can be obtained.

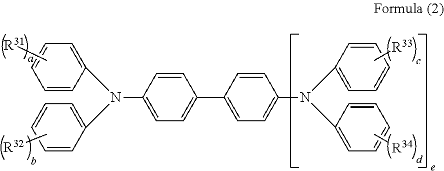

In the formula (2), R³¹ to R³⁴ each independently represent a hydrogen atom, or an alkyl group having 1 or more and 4 or less carbon atoms, “a”, “b”, “c”, and “d” each independently represent from 0 to 5, and “e” represents 0 or 1.

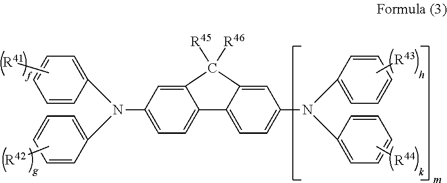

In the formula (3), R⁴¹ to R⁴⁴ each independently represent a hydrogen atom, or an alkyl group having 1 or more and 4 or less carbon atoms, R⁴⁵ and R⁴⁶ each independently represent an alkyl group having 1 or more and 8 or less carbon atoms, “f”, “g”, “h”, and “k” each independently represent from 0 to 5, and “m” represents 0 or 1.

The content of the charge-transporting substance in the charge-transporting layer is preferably 25 mass % or more and 70 mass % or less, more preferably 30 mass % or more and 55 mass % or less with respect to the total mass of the charge-transporting layer.

Examples of the resin include a polyester resin, a polycarbonate resin, an acrylic resin, and a polystyrene resin. Of those, a polycarbonate resin and a polyester resin are preferred. A polyarylate resin is particularly preferred as the polyester resin.

A content ratio (mass ratio) between the charge-transporting substance and the resin is preferably from 4:10 to 20:10, more preferably from 5:10 to 12:10.

In addition, the charge-transporting layer may contain an additive, such as an antioxidant, a UV absorber, a plasticizer, a leveling agent, a lubricity-imparting agent, or a wear resistance-improving agent. Specific examples thereof include a hindered phenol compound, a hindered amine compound, a sulfur compound, a phosphorus compound, a benzophenone compound, a siloxane-modified resin, a silicone oil, fluorine resin particles, polystyrene resin particles, polyethylene resin particles, silica particles, alumina particles, and boron nitride particles.

The charge-transporting layer has an average thickness of 5 μm or more and 50 μm or less, more preferably 8 μm or more and 40 μm or less, particularly preferably 10 μm or more and 30 μm or less.

The charge-transporting layer may be formed by preparing a coating liquid for a charge-transporting layer containing the above-mentioned materials and a solvent, forming a coat thereof, and drying the coat. Examples of the solvent to be used for the coating liquid include an alcohol-based solvent, a ketone-based solvent, an ether-based solvent, an ester-based solvent, and an aromatic hydrocarbon-based solvent. Of those solvents, an ether-based solvent or an aromatic hydrocarbon-based solvent is preferred.

### (2) Single-layer Photosensitive Layer

The single-layer photosensitive layer may be formed by preparing a coating liquid for a photosensitive layer containing the charge-generating substance, the charge-transporting substance, a resin, and a solvent, forming a coat thereof, and drying the coat.

Examples of the charge-generating substance, the charge-transporting substance, and the resin are the same as those of the materials in the section “(1) Laminated Photosensitive Layer.”

### [Process Cartridge and Electrophotographic Apparatus]

A process cartridge according to at least one embodiment of the present disclosure is removably mountable to a main body of an electrophotographic apparatus, and comprises the electrophotographic photosensitive member as mentioned above, and at least one unit selected from the group consisting of a charging unit, a developing unit, a transferring unit, and a cleaning unit.

In addition, an electrophotographic apparatus according to at least one embodiment of the present disclosure comprises the electrophotographic photosensitive member as mentioned above, a charging unit, an exposing unit, a developing unit, and a transferring unit.

An example of the schematic construction of an electrophotographic apparatus including a process cartridge including an electrophotographic photosensitive member is illustrated in FIGURE.

An electrophotographic photosensitive member 1 of a cylindrical shape is rotationally driven about a shaft 2 in a direction indicated by the arrow at a predetermined peripheral speed. The surface of the electrophotographic photosensitive member 1 is charged to a predetermined positive or negative potential by a charging unit 3. In FIGURE, a roller charging system based on a roller-type charging member is illustrated, but a charging system such as a corona charging system, a proximity charging system, or an injection charging system may be adopted. The charged surface of the electrophotographic photosensitive member 1 is irradiated with exposure light 4 from an exposing unit (not shown), and hence an electrostatic latent image corresponding to target image information is formed thereon. The electrostatic latent image formed on the surface of the electrophotographic photosensitive member 1 is developed with toner stored in a developing unit 5 to form a toner image on the surface of the electrophotographic photosensitive member 1. The toner image formed on the surface of the electrophotographic photosensitive member 1 is transferred by a transferring unit 6 onto a transfer material 7. The transfer material 7 onto which the toner image has been transferred is conveyed to a fixing unit 8, and is subjected to a treatment for fixing the toner image to be printed out to the outside of the electrophotographic apparatus. The electrophotographic apparatus may include a cleaning unit 9 for removing a deposit, such as the toner remaining on the surface of the electrophotographic photosensitive member 1 after the transfer. In addition, a so-called cleaner-less system configured to remove the deposit with the developing unit 5 or the like without separate arrangement of the cleaning unit 9 may be used. The electrophotographic apparatus may include an electricity-removing mechanism configured to subject the surface of the electrophotographic photosensitive member 1 to an electricity-removing treatment with pre-exposure light 10 from a pre-exposing unit (not shown). In addition, a guiding unit 12, such as a rail, may be arranged for removably mounting the process cartridge 11 onto the main body of the electrophotographic apparatus.

The electrophotographic photosensitive member according to at least one embodiment of the present disclosure may be used in, for example, a laser beam printer, an LED printer, a copying machine, a facsimile, and a multifunctional peripheral thereof

According to at least one embodiment of the present disclosure, the electrophotographic photosensitive member having a satisfactory suppressing effect on image smearing, and the process cartridge and the electrophotographic apparatus each including the electrophotographic photosensitive member can be provided.

The electrophotographic photosensitive member and the like according to at least one embodiment of the present disclosure are described in more detail below by way of Examples and Comparative Examples. The electrophotographic photosensitive member and the like according to at least one embodiment of the present disclosure are by no means limited to configurations embodied in the following Examples, and various modifications may be made without departing from the gist of the present disclosure. In the description in the following Examples, “part(s)” is by mass unless otherwise specified.

### Examples 1 to 49 and Comparative Examples 1 to 4

### <Support>

A cylindrical aluminum cylinder having a diameter of 29.9 mm, a length of 357.5 mm, and a thickness of 0.7 mm was used as the support.

### <Undercoat Layer>

100 Parts by mass of zinc oxide particles (specific surface area: 19 m²/g, powder resistance: 4.7×10⁶ acm) serving as a metal oxide were mixed with 500 parts by mass of toluene under stirring. 0.8 Part by mass of N-2-(aminoethyl)-3-aminopropylmethyldimethoxysilane (product name: KBM-602, manufactured by Shin-Etsu Chemical Co., Ltd.) was added as a silane coupling agent to the mixture, and the whole was stirred for 6 hours. After that, toluene was evaporated under reduced pressure, and the residue was dried under heating at 140° C. for 6 hours. Thus, surface-treated zinc oxide particles were obtained.

Next, 15 parts by mass of polyvinyl butyral (product name: S-LEC (trademark) B BM-1, manufactured by Sekisui Chemical Co., Ltd.) and 15 parts by mass of a blocked isocyanate (product name: SUMIDUR 3175, manufactured by Sumika Bayer Urethane Co., Ltd.) were dissolved in a mixed solution. The mixed solution is a mixed solution of 73.5 parts by mass of methyl ethyl ketone and 73.5 parts by mass of 1-butanol. 80.8 Parts by mass of the surface-treated zinc oxide particles prepared in the foregoing and 0.4 part by mass of 2,3,4-trihydroxybenzophenone (manufactured by Tokyo Chemical Industry Co., Ltd.) were added to the solution. After that, the mixture was dispersed with a sand mill apparatus using glass beads each having a diameter of 0.8 mm under an atmosphere at 23° C. for 3 hours. After the dispersion, the following materials were added to the resultant, and the mixture was stirred to prepare a coating liquid for an undercoat layer.
Silicone oil (product name: SH28PA, manufactured by Dow Corning Toray Co., Ltd.): 0.01 part by mass
Crosslinked polymethyl methacrylate (PMMA) particles (product name: TECHPOLYMER (trademark) SSX-103, manufactured by Sekisui Plastics Co., Ltd., average primary particle diameter: 3.1 μm): 5.6 parts by mass

The coating liquid for an undercoat layer was applied onto the support by dip coating, and the resultant coat was dried at 160° C. for 40 minutes to form an undercoat layer having a thickness of 18 μm.

### <Charge-Generating Layer>

The following four materials were loaded into a sand mill using glass beads each having a diameter of 1 mm, and were subjected to a dispersion treatment for 4 hours, followed by the addition of 700 parts by mass of ethyl acetate. Thus, a coating liquid for a charge-generating layer was prepared.
Hydroxygallium phthalocyanine crystal of a crystal form having strong peaks at Bragg angles 2θ±0.2° in CuKa characteristic X-ray diffraction of 7.4° and 28.2° (charge-generating substance): 20 parts by mass
Polyvinyl butyral (product name: S-LEC (trademark) B BX-1, manufactured by Sekisui Chemical Co., Ltd.): 10 parts by mass
Compound represented by the following formula (A): 0.2 part by mass
Cyclohexanone: 600 parts by mass

The coating liquid for a charge-generating layer was applied onto the undercoat layer by dip coating, and the resultant coat was dried at 80° C. for 15 minutes to form a charge-generating layer having a thickness of 0.18 μm.

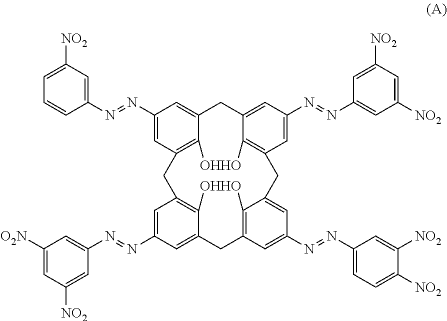 [SMILES: O=[N+]([O-])c1cccc(/N=N/c2cc3c(O)c(c2)Cc2cc(/N=N/c4cc([N+](=O)[O-])cc([N+](=O)[O-])c4)cc(c2O)Cc2cc(/N=N/c4ccc([N+](=O)[O-])c([N+](=O)[O-])c4)cc(c2O)Cc2cc(/N=N/c4cc([N+](=O)[O-])cc([N+](=O)[O-])c4)cc(c2O)C3)c1]

### <Charge-Transporting Layer>

Next, a coating liquid for a charge-transporting layer was produced.

100 Parts by mass of polycarbonate (product name: IUPILON (trademark) Z400, manufactured by Mitsubishi Engineering-Plastic Corporation, bisphenol Z-type polycarbonate) and a charge-transporting substance, whose kind was shown in Table 1 and whose amount was shown in the unit of parts by mass in Table 1, were mixed and dissolved in a mixed solvent of 600 parts by mass of xylene and 200 parts by mass of dimethoxymethane. Thus, the coating liquid for a charge-transporting layer was prepared.

Compounds corresponding to the charge-transporting substance used in the preparation of the coating liquid for a charge-transporting layer are described below.
Compound represented by the following formula (B) (charge-transporting substance)
Compound represented by the following formula (C) (charge-transporting substance)
Compound represented by the following formula (D) (charge-transporting substance)
Compound represented by the following formula (E) (charge-transporting substance)

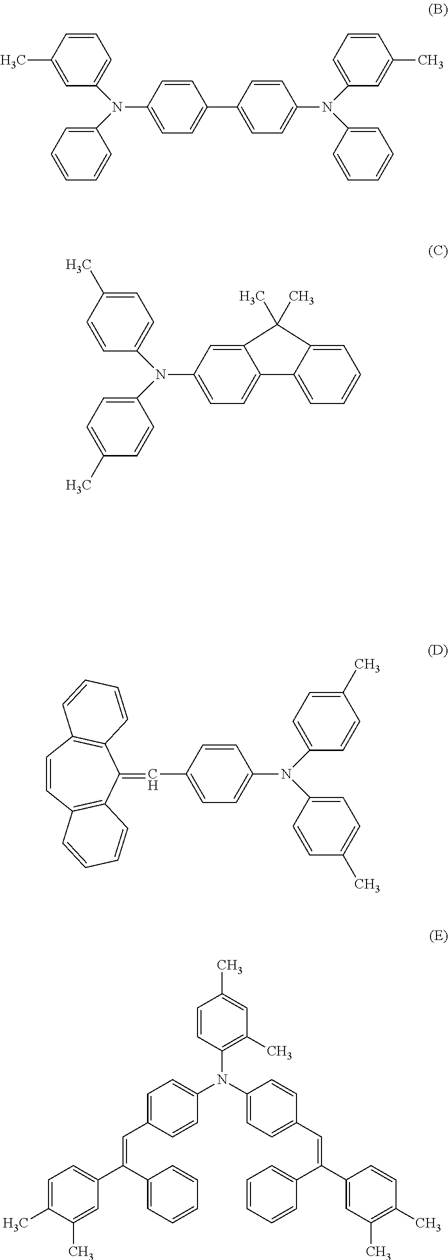

The coating liquid for a charge-transporting layer was applied onto the charge-generating layer by dip coating, and the resultant coat was dried at 110° C. for 30 minutes to form a charge-transporting layer having a thickness of 18 μm.

With regard to the charge-transporting layers of the photosensitive members of Examples 1 to 49 and Comparative Examples 1 to 4, the kinds and amounts of the charge-transporting substances in the charge-transporting layers are shown in Table 1. In Table 1, the terms “Formula (B)” to “Formula (E)” refer to the compound represented by the formula (B) to the compound represented by the formula (E).

TABLE 1

| | Charge-transporting layer | | | | | |
|---|---|---|---|---|---|---|
| | Charge-transporting | | Charge-transporting | | Charge-transporting | |
| | substance | | substance | | substance | |
| | Kind | Amount (parts) | Kind | Amount (parts) | Kind | Amount (parts) |
| Example 1 | Formula (B) | 30 | Formula (C) | 60 | Formula (D) | 10 |
| Example 2 | Formula (B) | 30 | Formula (C) | 60 | Formula (D) | 10 |
| Example 3 | Formula (B) | 30 | Formula (C) | 60 | Formula (D) | 10 |
| Example 4 | Formula (B) | 30 | Formula (C) | 60 | Formula (D) | 10 |
| Example 5 | Formula (B) | 30 | Formula (C) | 60 | Formula (D) | 10 |
| Example 6 | Formula (B) | 30 | Formula (C) | 60 | Formula (D) | 10 |
| Example 7 | Formula (B) | 30 | Formula (C) | 60 | Formula (D) | 10 |
| Example 8 | Formula (B) | 30 | Formula (C) | 60 | Formula (D) | 10 |
| Example 9 | Formula (B) | 30 | Formula (C) | 60 | Formula (D) | 10 |
| Example 10 | Formula (B) | 30 | Formula (C) | 60 | Formula (D) | 10 |
| Example 11 | Formula (B) | 30 | Formula (C) | 60 | Formula (D) | 10 |
| Example 12 | Formula (B) | 30 | Formula (C) | 60 | Formula (D) | 10 |
| Example 13 | Formula (B) | 30 | Formula (C) | 60 | Formula (D) | 10 |
| Example 14 | Formula (B) | 30 | Formula (C) | 60 | Formula (D) | 10 |
| Example 15 | Formula (B) | 30 | Formula (C) | 60 | Formula (D) | 10 |
| Example 16 | Formula (B) | 30 | Formula (C) | 60 | Formula (D) | 10 |
| Example 17 | Formula (B) | 30 | Formula (C) | 60 | Formula (D) | 10 |
| Example 18 | Formula (B) | 30 | Formula (C) | 60 | Formula (D) | 10 |
| Example 19 | Formula (B) | 30 | Formula (C) | 60 | Formula (D) | 10 |
| Example 20 | Formula (B) | 30 | Formula (C) | 60 | Formula (D) | 10 |
| Example 21 | Formula (B) | 30 | Formula (C) | 60 | Formula (D) | 10 |
| Example 22 | Formula (B) | 100 | — | — | — | — |
| Example 23 | Formula (C) | 100 | — | — | — | — |
| Example 24 | Formula (E) | 100 | — | — | — | — |
| Example 25 | Formula (B) | 30 | Formula (C) | 60 | Formula (D) | 10 |
| Example 26 | Formula (B) | 30 | Formula (C) | 60 | Formula (D) | 10 |
| Example 27 | Formula (B) | 30 | Formula (C) | 60 | Formula (D) | 10 |
| Example 28 | Formula (B) | 30 | Formula (C) | 60 | Formula (D) | 10 |
| Example 29 | Formula (B) | 30 | Formula (C) | 60 | Formula (D) | 10 |
| Example 30 | Formula (B) | 30 | Formula (C) | 60 | Formula (D) | 10 |
| Example 31 | Formula (B) | 30 | Formula (C) | 60 | Formula (D) | 10 |
| Example 32 | Formula (B) | 30 | Formula (C) | 60 | Formula (D) | 10 |
| Example 33 | Formula (B) | 30 | Formula (C) | 60 | Formula (D) | 10 |
| Example 34 | Formula (B) | 30 | Formula (C) | 60 | Formula (D) | 10 |
| Example 35 | Formula (B) | 30 | Formula (C) | 60 | Formula (D) | 10 |
| Example 36 | Formula (B) | 30 | Formula (C) | 60 | Formula (D) | 10 |
| Example 37 | Formula (B) | 30 | Formula (C) | 60 | Formula (D) | 10 |
| Example 38 | Formula (B) | 30 | Formula (C) | 60 | Formula (D) | 10 |
| Example 39 | Formula (B) | 30 | Formula (C) | 60 | Formula (D) | 10 |
| Example 40 | Formula (B) | 30 | Formula (C) | 60 | Formula (D) | 10 |
| Example 41 | Formula (B) | 30 | Formula (C) | 60 | Formula (D) | 10 |
| Example 42 | Formula (B) | 30 | Formula (C) | 60 | Formula (D) | 10 |
| Example 43 | Formula (B) | 30 | Formula (C) | 60 | Formula (D) | 10 |
| Example 44 | Formula (B) | 30 | Formula (C) | 60 | Formula (D) | 10 |
| Example 45 | Formula (B) | 30 | Formula (C) | 60 | Formula (D) | 10 |
| Example 46 | Formula (B) | 30 | Formula (C) | 60 | Formula (D) | 10 |
| Example 47 | Formula (B) | 100 | — | — | — | — |
| Example 48 | Formula (C) | 100 | — | — | — | — |
| Example 49 | Formula (E) | 100 | — | — | — | — |
| Comparative | Formula (B) | 30 | Formula (C) | 60 | Formula (D) | 10 |
| Example 1 | | | | | | |
| Comparative | Formula (B) | 30 | Formula (C) | 60 | Formula (D) | 10 |
| Example 2 | | | | | | |
| Comparative | Formula (B) | 30 | Formula (C) | 60 | Formula (D) | 10 |
| Example 3 | | | | | | |
| Comparative | Formula (B) | 30 | Formula (C) | 60 | Formula (D) | 10 |
| Example 4 | | | | | | |

### <Surface Layer>

Next, a coating liquid for a surface layer was produced.

100 Parts by mass of 1-propanol was mixed with melamine resin-containing particles or acrylic resin-containing particles, a compound represented by the formula (1), and a charge-transporting compound having a polymerizable functional group, whose kinds were shown in Table 2 and whose amounts were each shown in the unit of parts by mass in Table 2, followed by stirring. Thus, the coating liquid for a surface layer was obtained.

Particles corresponding to the melamine resin-containing particles or the acrylic resin-containing particles used in the preparation of the coating liquid for a surface layer are described below.
Particles 1: EPOSTAR S manufactured by Nippon Shokubai Co., Ltd. (melamine formaldehyde resin particles, average particle diameter: 0.2 μm)
Particles 2: EPOSTAR S6 manufactured by Nippon Shokubai Co., Ltd. (melamine formaldehyde resin particles, average particle diameter: 0.4 μm)
Particles 3: EPOSTAR S12 manufactured by Nippon Shokubai Co., Ltd. (melamine formaldehyde resin particles, average particle diameter: 1.2 μm)
Particles 4: XX-160AP manufactured by Sekisui Plastics Co., Ltd. (polymethyl methacrylate particles, average particle diameter: 0.1 μm)
Particles 5: SSX-102 manufactured by Sekisui Plastics Co., Ltd. (polymethyl methacrylate particles, average particle diameter: 2.0 μm)
Particles 6: MG-451 manufactured by Nippon Paint Industrial Coatings Co., Ltd. (polystyrene acrylic particles, average particle diameter: 0.1 μm)
Particles 7: FS-301 manufactured by Nippon Paint Industrial Coatings Co., Ltd. (polystyrene acrylic particles, average particle diameter: 1.0 μm)

The compound corresponding to the compound represented by the formula (1) and the charge-transporting compound having a polymerizable functional group, which were used in the preparation of the coating liquid for a surface layer in each of Examples and Comparative Examples, are shown as a formula number in Exemplified Compounds of the compound represented by the formula (1) and a formula number in Exemplified Compounds of the charge-transporting compound having a polymerizable functional group, respectively in Table 2. However, the term “Formula (F)” refers to trimethylolpropane triacrylate represented by the following formula (F) (product name: KAYARAD TMPTA, manufactured by Nippon Kayaku Co., Ltd.), which was used instead of the compound represented by the formula (1).

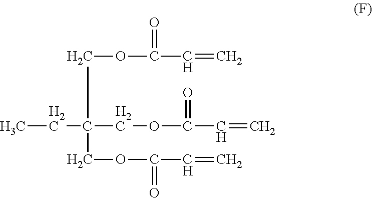 [SMILES: C=CC(=O)OCC(CC)(COC(=O)C=C)COC(=O)C=C]

The coating liquids for surface layers were each applied onto the charge-transporting layer by dip coating, and the resultant coat was dried at 40° C. for 6 minutes. After that, in a nitrogen atmosphere, the coat was irradiated with an electron beam for 1.6 seconds while the support (body to be irradiated) was rotated at 200 rpm. Conditions for the electron beam irradiation were set so that the absorbed dose of the beam became 8,000 Gy at an acceleration voltage of 70 kV. Subsequently, a temperature in the nitrogen atmosphere was increased from 25° C. to 120° C. over 30 seconds, and the coat was heated. The oxygen concentration of the atmosphere at the time of the electron beam irradiation and that at the time of the heating after the irradiation were each 15 ppm. Next, the heated coat was subjected to a heating treatment at 100° C. for 30 minutes in air to form a surface layer having a thickness of 5 μm. Thus, an electrophotographic photosensitive member was produced.

With regard to the surface layer of each of the photosensitive members of Examples 1 to 49 and Comparative Examples 1 to 4, the values of the ratios B/A, B/C, and A/(A+B+C) when the mass of the melamine resin-containing particles or the acrylic resin-containing particles is represented by A, the mass of a moiety derived from the compound represented by the formula (1) is represented by B, and the mass of a moiety derived from the charge-transporting compound having a polymerizable functional group is represented by C are shown in Table 2.

TABLE 2

| | Surface layer | | | | | | | | |
|---|---|---|---|---|---|---|---|---|---|
| | | | | | Charge- | | | | |
| | Melamine resin- | | | | transporting | | | | |
| | containing particles or | | | | compound having | | | | |
| | acrylic resin- | | Compound of | | polymerizable | | | | |
| | containing particles | | formula (1) | | functional group | | | | |
| | | Amount | | Amount | | Amount | | | |
| | Kind | (parts) | Kind | (parts) | Kind | (parts) | B/A | B/C | A/(A + B + C) |
| Example 1 | Particles 1 | 14.0 | 1-3 | 25.8 | 2-1 | 60.2 | 184.3% | 42.9% | 14.0% |
| Example 2 | Particles 1 | 7.0 | 1-3 | 27.9 | 2-1 | 65.1 | 398.6% | 42.9% | 7.0% |
| Example 3 | Particles 1 | 7.0 | 1-3 | 1.9 | 2-1 | 91.1 | 27.1% | 2.1% | 7.0% |
| Example 4 | Particles 1 | 10.2 | 1-3 | 26.9 | 2-1 | 62.9 | 263.7% | 42.8% | 10.2% |
| Example 5 | Particles 1 | 14.0 | 1-3 | 1.7 | 2-1 | 84.3 | 12.1% | 2.0% | 14.0% |
| Example 6 | Particles 1 | 14.0 | 1-3 | 4.3 | 2-1 | 81.7 | 30.7% | 5.3% | 14.0% |
| Example 7 | Particles 1 | 21.0 | 1-3 | 1.6 | 2-1 | 77.4 | 7.6% | 2.1% | 21.0% |
| Example 8 | Particles 1 | 21.0 | 1-3 | 4.0 | 2-1 | 75.1 | 19.0% | 5.3% | 21.0% |
| Example 9 | Particles 1 | 21.0 | 1-3 | 23.7 | 2-1 | 55.3 | 112.9% | 42.9% | 21.0% |
| Example 10 | Particles 1 | 21.0 | 1-3 | 39.5 | 2-1 | 39.5 | 188.1% | 100.0% | 21.0% |
| Example 11 | Particles 1 | 27.0 | 1-3 | 21.9 | 2-1 | 51.1 | 81.1% | 42.9% | 27.0% |
| Example 12 | Particles 1 | 34.0 | 1-3 | 3.3 | 2-1 | 62.7 | 9.7% | 5.3% | 34.0% |
| Example 13 | Particles 1 | 34.0 | 1-3 | 19.8 | 2-1 | 46.2 | 58.2% | 42.9% | 34.0% |
| Example 14 | Particles 1 | 41.0 | 1-3 | 17.7 | 2-1 | 41.3 | 43.2% | 42.9% | 41.0% |
| Example 15 | Particles 2 | 14.0 | 1-3 | 25.8 | 2-1 | 60.2 | 184.3% | 42.9% | 14.0% |
| Example 16 | Particles 3 | 14.0 | 1-3 | 25.8 | 2-1 | 60.2 | 184.3% | 42.9% | 14.0% |
| Example 17 | Particles 1 | 14.0 | 1-1 | 25.8 | 2-1 | 60.2 | 184.3% | 42.9% | 14.0% |
| Example 18 | Particles 1 | 14.0 | 1-2 | 25.8 | 2-1 | 60.2 | 184.3% | 42.9% | 14.0% |
| Example 19 | Particles 1 | 14.0 | 1-3 | 25.8 | 2-2 | 60.2 | 184.3% | 42.9% | 14.0% |
| Example 20 | Particles 1 | 14.0 | 1-3 | 25.8 | 2-3 | 60.2 | 184.3% | 42.9% | 14.0% |
| Example 21 | Particles 1 | 14.0 | 1-3 | 25.8 | 2-4 | 60.2 | 184.3% | 42.9% | 14.0% |
| Example 22 | Particles 1 | 14.0 | 1-3 | 25.8 | 2-1 | 60.2 | 184.3% | 42.9% | 14.0% |
| Example 23 | Particles 1 | 14.0 | 1-3 | 25.8 | 2-1 | 60.2 | 184.3% | 42.9% | 14.0% |
| Example 24 | Particles 1 | 14.0 | 1-3 | 25.8 | 2-1 | 60.2 | 184.3% | 42.9% | 14.0% |
| Example 25 | Particles 4 | 10.9 | 1-3 | 26.7 | 2-1 | 62.4 | 245.0% | 42.8% | 10.9% |
| Example 26 | Particles 4 | 5.5 | 1-3 | 28.4 | 2-1 | 66.2 | 516.4% | 42.9% | 5.5% |
| Example 27 | Particles 4 | 5.5 | 1-3 | 1.9 | 2-1 | 92.6 | 34.5% | 2.1% | 5.5% |
| Example 28 | Particles 4 | 8.2 | 1-3 | 27.5 | 2-1 | 64.3 | 335.4% | 42.8% | 8.2% |
| Example 29 | Particles 4 | 10.9 | 1-3 | 1.8 | 2-1 | 87.3 | 16.5% | 2.1% | 10.9% |
| Example 30 | Particles 4 | 10.9 | 1-3 | 4.5 | 2-1 | 84.6 | 41.3% | 5.3% | 10.9% |
| Example 31 | Particles 4 | 16.4 | 1-3 | 1.7 | 2-1 | 81.9 | 10.4% | 2.1% | 16.4% |
| Example 32 | Particles 4 | 16.4 | 1-3 | 4.2 | 2-1 | 79.4 | 25.6% | 5.3% | 16.4% |
| Example 33 | Particles 4 | 16.4 | 1-3 | 25.1 | 2-1 | 58.5 | 153.0% | 42.9% | 16.4% |
| Example 34 | Particles 4 | 16.4 | 1-3 | 41.8 | 2-1 | 41.8 | 254.9% | 100.0% | 16.4% |
| Example 35 | Particles 4 | 21.8 | 1-3 | 23.5 | 2-1 | 54.7 | 107.8% | 43.0% | 21.8% |
| Example 36 | Particles 4 | 27.3 | 1-3 | 3.7 | 2-1 | 69.1 | 13.6% | 5.4% | 27.3% |
| Example 37 | Particles 4 | 27.3 | 1-3 | 21.8 | 2-1 | 50.9 | 79.9% | 42.8% | 27.3% |
| Example 38 | Particles 4 | 32.7 | 1-3 | 20.2 | 2-1 | 47.1 | 61.8% | 42.9% | 32.7% |
| Example 39 | Particles 5 | 10.9 | 1-3 | 26.7 | 2-1 | 62.4 | 245.0% | 42.8% | 10.9% |
| Example 40 | Particles 6 | 10.9 | 1-3 | 26.7 | 2-1 | 62.4 | 245.0% | 42.8% | 10.9% |
| Example 41 | Particles 7 | 10.9 | 1-3 | 26.7 | 2-1 | 62.4 | 245.0% | 42.8% | 10.9% |
| Example 42 | Particles 4 | 10.9 | 1-1 | 26.7 | 2-1 | 62.4 | 245.0% | 42.8% | 10.9% |
| Example 43 | Particles 4 | 10.9 | 1-2 | 26.7 | 2-1 | 62.4 | 245.0% | 42.8% | 10.9% |
| Example 44 | Particles 4 | 10.9 | 1-3 | 26.7 | 2-2 | 62.4 | 245.0% | 42.8% | 10.9% |
| Example 45 | Particles 4 | 10.9 | 1-3 | 26.7 | 2-3 | 62.4 | 245.0% | 42.8% | 10.9% |
| Example 46 | Particles 4 | 10.9 | 1-3 | 26.7 | 2-4 | 62.4 | 245.0% | 42.8% | 10.9% |
| Example 47 | Particles 4 | 10.9 | 1-3 | 26.7 | 2-1 | 62.4 | 245.0% | 42.8% | 10.9% |
| Example 48 | Particles 4 | 10.9 | 1-3 | 26.7 | 2-1 | 62.4 | 245.0% | 42.8% | 10.9% |
| Example 49 | Particles 4 | 10.9 | 1-3 | 26.7 | 2-1 | 62.4 | 245.0% | 42.8% | 10.9% |
| Comparative | Particles 1 | 14.0 | None | 0.0 | 2-1 | 60.2 | 0.0% | 0.0% | 18.9% |
| Example 1 | | | | | | | | | |
| Comparative | Particles 1 | 14.0 | Formula | 25.8 | 2-1 | 60.2 | 0.0% | 0.0% | 18.9% |
| Example 2 | | | (F) | | | | | | |
| Comparative | Particles 4 | 14.0 | None | 0.0 | 2-1 | 60.2 | 0.0% | 0.0% | 18.9% |
| Example 3 | | | | | | | | | |
| Comparative | Particles 4 | 14.0 | Formula | 25.8 | 2-1 | 60.2 | 0.0% | 0.0% | 18.9% |
| Example 4 | | | (F) | | | | | | |

### [Evaluation]

### <Evaluation of Image Smearing>

The resultant electrophotographic photosensitive members were each mounted on the cyan station of a reconstructed machine of an electrophotographic apparatus (multifunction machine) manufactured by Canon Inc. (product name: imageRunner (trademark)-ADV C5560), which was an evaluation apparatus, and an image evaluation under an environment having a temperature of 32.5° C. and a humidity of 85% RH was performed. The reconstruction point of the apparatus was as follows: the regulation of a potential to be applied from a charging roller to the photosensitive member and image exposure laser power was enabled. Further, the apparatus was used while the power sources of the heater of the main body of a copying machine and the cassette heater of the machine were turned off

The image evaluation was performed as described below. Thirty thousand-sheet continuous image formation was performed with a test chart having a print percentage of 5%. After the completion of the image formation, power supply to the multifunction machine was stopped, and the machine was left to stand for 3 days. After the standing for 3 days, power supply to the copying machine was started again, and a square lattice image having a line width of 0.1 mm and a line interval of 10 mm, and a letter image (Iroha image) in which hiragana letters “i”, “ro”, and “ha” were repeated were output on A4 horizontal size paper.

The resultant images were evaluated for their image smearing levels by the following criteria. In at least one embodiment of the present disclosure, it was judged that while a suppressing effect on image smearing was sufficiently obtained in each of ranks A, B, and C, no suppressing effect on image smearing was obtained in each of ranks D and E. The results are shown in Table 3.
Rank A: No image defects are observed in both of the lattice image and the Iroha image.
Rank B: Part of the lattice image blurs, but no image defect is observed in the Iroha image.
Rank C: Part of the lattice image blurs, and part of the Iroha image pales.
Rank D: The lattice image partially disappears, and the entirety of the Iroha image pales.
Rank E: The entirety of the lattice image disappears, and the entirety of the Iroha image pales.

### <Evaluation of Lubricity>

The measurement of a dynamic friction coefficient with a rotary friction wear tester was performed as the evaluation of each of the resultant electrophotographic photosensitive members for its lubricity. The rotary friction wear tester is an apparatus including: a mechanism configured to support and rotate the electrophotographic photosensitive member; and a mechanism configured to bring a cleaning blade into abutment with the surface of the electrophotographic photosensitive member at a desired angle and in a desired penetration amount to support the electrophotographic photosensitive member. The mechanism configured to bring the cleaning blade into abutment with the surface to support the electrophotographic photosensitive member includes a detecting unit for detecting a load.

A urethane rubber blade having a Wallace hardness (value measured by an IRHD hardness test method M) of 77° and a modulus of repulsion elasticity of 20% was used as the cleaning blade.

The blade having a width of 10 mm, a thickness of 2 mm, and a free length of 10 mm was brought into abutment with the surface of the electrophotographic photosensitive member at a set angle of 20° and in a penetration amount of 0.7 mm to support the electrophotographic photosensitive member, and the electrophotographic photosensitive member was rotated at a number of revolutions of 168 rpm. One minute after the start of the rotation, a load in the tangential direction of the electrophotographic photosensitive member in the blade-abutting portion, and a load in the normal direction thereof were read from the detecting unit, and the dynamic friction coefficient was calculated by dividing the load in the tangential direction by the load in the normal direction. The results are shown in Table 3.

### <Evaluation of Adhesiveness>

Adhesiveness between the surface layer and charge-transporting layer of each of the resultant electrophotographic photosensitive members was evaluated by using a crosscut method. Six notches reaching the substrate of the electrophotographic photosensitive member were produced with a box cutter at a pitch of 1 mm. Six notches intersecting the notches at 90° were similarly produced. Thus, 25 grids were produced. CELLOTAPE (trademark) was strongly brought into pressure contact with the grid portions, and an end of the tape was peeled at an angle of 45° in one stroke, followed by the evaluation of the adhesiveness by the number of peeled squares. Evaluation criteria are as described below. The results are shown in Table 3.
Rank A: 0 squares
Rank B: 1 to 5 squares
Rank C: 5 or more squares

TABLE 3

| | Evaluation | Lubricity | |
|---|---|---|---|
| | Image | (dynamic | |
| | smearing | friction | Adhesiveness |
| | (rank) | coefficient) | (rank) |
| Example 1 | A | 1.2 | A |
| Example 2 | B | 1.5 | A |
| Example 3 | C | 1.5 | A |
| Example 4 | A | 1.3 | A |
| Example 5 | B | 1.2 | A |
| Example 6 | A | 1.2 | A |
| Example 7 | C | 1.2 | A |
| Example 8 | A | 1.2 | A |
| Example 9 | A | 1.2 | A |
| Example 10 | A | 1.2 | A |
| Example 11 | A | 1.2 | A |
| Example 12 | A | 1.2 | A |
| Example 13 | A | 1.2 | A |
| Example 14 | B | 1.1 | A |
| Example 15 | A | 1.2 | A |
| Example 16 | A | 1.2 | A |
| Example 17 | B | 1.2 | A |
| Example 18 | A | 1.2 | A |
| Example 19 | A | 1.2 | A |
| Example 20 | A | 1.2 | A |
| Example 21 | A | 1.2 | A |
| Example 22 | A | 1.2 | A |
| Example 23 | A | 1.2 | A |
| Example 24 | A | 1.2 | B |
| Example 25 | A | 1.2 | A |
| Example 26 | B | 1.5 | A |
| Example 27 | C | 1.5 | A |
| Example 28 | A | 1.3 | A |
| Example 29 | B | 1.2 | A |
| Example 30 | A | 1.2 | A |
| Example 31 | C | 1.2 | A |
| Example 32 | A | 1.2 | A |
| Example 33 | A | 1.2 | A |
| Example 34 | A | 1.2 | A |
| Example 35 | A | 1.2 | A |
| Example 36 | A | 1.2 | A |
| Example 37 | A | 1.2 | A |
| Example 38 | B | 1.1 | A |
| Example 39 | A | 1.2 | A |
| Example 40 | A | 1.2 | A |
| Example 41 | A | 1.2 | A |
| Example 42 | B | 1.2 | A |
| Example 43 | A | 1.2 | A |
| Example 44 | A | 1.2 | A |
| Example 45 | A | 1.2 | A |
| Example 46 | A | 1.2 | A |
| Example 47 | A | 1.2 | A |
| Example 48 | A | 1.2 | A |
| Example 49 | A | 1.2 | B |
| Comparative Example 1 | D | 1.2 | A |
| Comparative Example 2 | D | 1.2 | A |
| Comparative Example 3 | D | 1.2 | A |
| Comparative Example 4 | D | 1.2 | A |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-086302, filed Apr. 26, 2019, which is hereby incorporated by reference herein in its entirety.

What is claimed is:

1. An electrophotographic photosensitive member comprising:
a support;
a photosensitive layer; and
a surface layer,
wherein the surface layer contains:
at least one of melamine resin-containing particles and acrylic resin-containing particles; and
a polymerized product of a composition containing
a charge-transporting compound having a polymerizable functional group, and
a compound represented by formula (1): 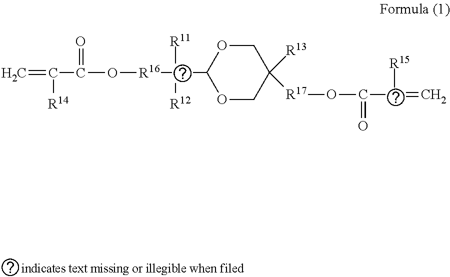
in the formula (1), R¹¹ and R¹² each independently represent an alkyl group having 1 or more and 4 or less carbon atoms, or a substituted or unsubstituted aryl group, and R¹¹ and R¹² may be bonded to each other to form an aliphatic ring, R¹³ represents an alkyl group having 1 or more and 4 or less carbon atoms, R¹⁴ and R¹⁵ each independently represent a hydrogen atom or a methyl group, and R¹⁶ and R¹⁷ each independently represent an alkylene group having 1 or more and 4 or less carbon atoms.

2. The electrophotographic photosensitive member according to claim 1,
wherein the surface layer contains the melamine resin-containing particles, and
wherein when a mass of the melamine resin-containing particles is represented by A, and a mass of a moiety derived from the compound represented by the formula (1) is represented by B, a ratio (B/A) of the B to the A is 9.7 mass % or more.

3. The electrophotographic photosensitive member according to claim 1,
wherein the surface layer contains the melamine resin-containing particles, and
wherein when a mass of the melamine resin-containing particles is represented by A, a mass of a moiety derived from the compound represented by the formula (1) is represented by B, and a mass of a moiety derived from the charge-transporting compound having a polymerizable functional group is represented by C, a relationship A/(A+B+C) among the A, the B, and the C is 10.2 mass % or more and 34.0 mass % or less.

4. The electrophotographic photosensitive member according to claim 1,
wherein the surface layer contains the acrylic resin-containing particles, and
wherein when a mass of the acrylic resin-containing particles is represented by A, and a mass of a moiety derived from the compound represented by the formula (1) is represented by B, a ratio (B/A) of the B to the A is 13.6 mass % or more.

5. The electrophotographic photosensitive member according to claim 1,
wherein the surface layer contains the acrylic resin-containing particles, and
wherein when a mass of the acrylic resin-containing particles is represented by A, a mass of a moiety derived from the compound represented by the formula (1) is represented by B, and a mass of a moiety derived from the charge-transporting compound having a polymerizable functional group is represented by C, a relationship A/(A+B+C) among the A, the B, and the C is 8.2 mass % or more and 27.3 mass % or less.

6. The electrophotographic photosensitive member according to claim 1, wherein when a mass of a moiety derived from the charge-transporting compound having a polymerizable functional group is represented by C, and a mass of a moiety derived from the compound represented by the formula (1) is represented by B, a ratio (B/C) of the B to the C is 5.3 mass % or more.

7. The electrophotographic photosensitive member according to claim 1, wherein the photosensitive layer contains at least one charge-transporting compound selected from the group consisting charge-transporting compounds represented by formula (2) and charge-transporting compounds represented by formula (3): 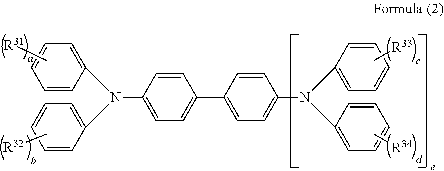
in the formula (2), R³¹ to R³⁴ each independently represent a hydrogen atom, or an alkyl group having 1 or more and 4 or less carbon atoms, “a”, “b”, “c”, and “d” each independently represent from 0 to 5, and “e” represents 0 or 1; 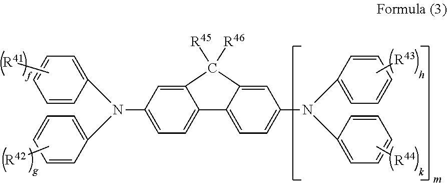
in the formula (3), R⁴¹ to R⁴⁴ each independently represent a hydrogen atom, or an alkyl group having 1 or more and 4 or less carbon atoms, R⁴⁵ and R⁴⁶ each independently represent an alkyl group having 1 or more and 8 or less carbon atoms, “f”, “g”, “h”, and “k” each independently represent from 0 to 5, and “m” represents 0 or 1.

8. The electrophotographic photosensitive member according to claim 1, wherein at least one of R¹¹ or R¹² of the compound represented by the formula (1) represents an alkyl group having 2 or more carbon atoms.

9. A process cartridge removably mounted onto a main body of an electrophotographic apparatus, the process cartridge comprising:
an electrophotographic photosensitive member; and
at least one unit selected from the group consisting of a charging unit, a developing unit, and a cleaning unit,
wherein the electrophotographic photosensitive member includes a support, a photosensitive layer, and a surface layer, and
wherein the surface layer contains
at least one of melamine resin-containing particles or acrylic resin-containing particles; and
a polymerized product of a composition containing
a charge-transporting compound having a polymerizable functional group; and
a compound represented by formula (1): 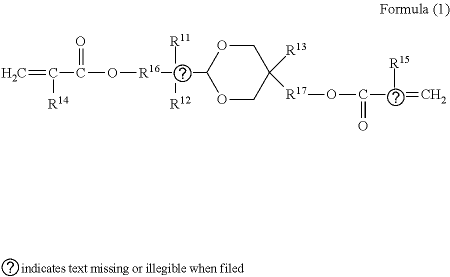
in the formula (1), R¹¹ and R¹² each independently represent an alkyl group having 1 or more and 4 or less carbon atoms, or a substituted or unsubstituted aryl group, and R¹¹ and R¹² may be bonded to each other to form an aliphatic ring, R¹³ represents an alkyl group having 1 or more and 4 or less carbon atoms, R¹⁴ and R¹⁵ each independently represent a hydrogen atom or a methyl group, and R¹⁶ and R¹⁷ each independently represent an alkylene group having 1 or more and 4 or less carbon atoms.

10. An electrophotographic apparatus comprising:
an electrophotographic photosensitive member, a charging unit, an exposing unit, a developing unit, and a transferring unit,
wherein the electrophotographic photosensitive member includes a support, a photosensitive layer, and a surface layer, and
wherein the surface layer contains
at least one of melamine resin-containing particles and acrylic resin-containing particles: and
a polymerized product of a composition containing:
a charge-transporting compound having a polymerizable functional group; and
a compound represented by formula (1): 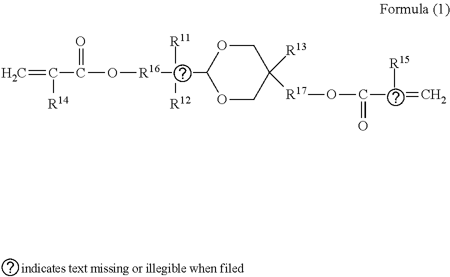
in the formula (1), R¹¹ and R¹² each independently represent an alkyl group having 1 or more and 4 or less carbon atoms, or a substituted or unsubstituted aryl group, and R¹¹ and R¹² may be bonded to each other to form an aliphatic ring, R¹³ represents an alkyl group having 1 or more and 4 or less carbon atoms, R¹⁴ and R¹⁵ each independently represent a hydrogen atom or a methyl group, and R¹⁶ and R¹⁷ each independently represent an alkylene group having 1 or more and 4 or less carbon atoms.
